(19) United States
(12) Patent Application Publication
(10) Pub. No.: US 2016/0168385 A1
(43) Pub. Date: Jun. 16, 2016

(54) Coated Particles and Method of Coating Particles

(71) Applicant: SG VENTURES PTY LIMITED, Sydney, New South Wales (AU)

(72) Inventors: Christophe Jean Alexandre Barbé, Five Dock (AU); Kim Suzanne Finnie, Chatswood (AU)

(21) Appl. No.: 14/906,965

(22) PCT Filed: Jul. 29, 2014
(86) PCT No.: PCT/AU2014/050156

§ 371 Date: Jan. 22, 2016

(30) Foreign Application Priority Data
Jul. 29, 2013 (AU) 2013902811

(51) Int. Cl. C09B 67/08; C09B 67/02

(52) U.S. Cl. CPC C09B 67/0007; C09B 67/0097; C09B 67/0008

(57) ABSTRACT

Coated particles include a core particle and a hybrid inorganic/organic layer coating the core particle. The hybrid inorganic/organic layer comprises a network of an inorganic component and at least one organofunctional silane component having organic functionalities which have not been polymerised. A method of coating particles comprising combining the particles with a surfactant and a hydrophilic liquid to form an emulsion with a hydrophobic phase containing the particles dispersed in a continuous hydrophilic phase, adding an organofunctional silane and an inorganic component precursor to the emulsion and heating the emulsion, adding a catalyst to the emulsion, and forming a hybrid organic/inorganic layer from the organofunctional silane and the inorganic component precursor on the particles to produce coated particles.

### FIELD OF INVENTION

The disclosure relates to coated particles and a method of coating particles. In particular, the disclosure relates to a method of coating particles, such as silica-based particles loaded with an active or other dopant, whereby a hybrid inorganic/organic layer is coated onto the particles. The coating advantageously reduces or eliminates exposure of the core particles to the external environment.

### BACKGROUND ART

Processes involving the encapsulation of active molecules in ceramic particles for the purpose of subsequent controlled release into the surrounding environment are known. The actives may be releasable due to the porous nature of the ceramic matrix. There are, however, applications in which release of actives must be minimized, such as in the encapsulation of dyes for purposes which require stability in the colour of the particles. In other situations, it may be the composition of the matrix forming the particles which must not change, rather than the encapsulation of an active that must be preserved. In both situations, a coating which prevents the leaching of an encapsulated active, or protects the core material from contact with elements in the surrounding environment, is desirable.

K. Finnie, C. Barbe, and L. Kong (WO 2006/133519) disclose a method for producing organically modified silica particles with incorporated hydrophobic actives. A more recent study by Kong et al (‘Synthesis of silica nanoparticles using oil-in-water emulsion and the porosity analysis’, Linggen Kong, Akira Uedono, Suzanne V. Smith, Yukihiro Yamashita and Ilkay Chironi, J. Sol-gel Science Technol., 64 (2), 309-314, 2012) using positron annihilation lifetime spectroscopy, showed that freeze-dried particles made by this method, using 60% phenyltrimethoxysilane and 40% tetraethylorthosilicate as reagents, have approximately 0.6 nm pores. The rate of release of actives into the surrounding medium is dependent on several factors, such as the size of the active molecule, the affinity of the active for the matrix and the solubility of the active in the medium. Typically, the immersion of particles in solvent results in rapid leaching of hydrophobic molecules from the particles.

WO 2004/081222 describes the difficulty in preventing leaching of water-soluble dyes encapsulated in porous sol-gel particles. The method described, which aims to prevent leaching, employs immersion of the particles in alkoxide, or alkoxide and organic solvent to form a coating on the particles. While this is suitable for water-soluble actives, hydrophobic molecules would be rapidly leached during this processing step, and hence such an approach would be inappropriate for protecting organically modified silica particles with encapsulated hydrophobes.

It would be advantageous if a coating method could be devised that results in rapid condensation of a coating layer on particles which minimizes leaching of any encapsulated hydrophobic active, and which reduces or prevents ingress of the surrounding medium into the core material forming the particles.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF INVENTION

In one aspect there is provided coated particles comprising:
a core particle; and
a hybrid inorganic/organic layer coating the core particle,
   wherein the hybrid inorganic/organic layer comprises a network of an inorganic component and at least one organofunctional silane component having organic functionalities which have not been polymerised.

As used herein the term “network” refers to a layer structure in which the inorganic component comprises the body of the layer throughout which the organofunctional silane is dispersed, generally relatively homogeneously. The term is not intended to include situations where a layer of inorganic material, such as a metal oxide, is coated onto the metallic substrate and functionality applied to an external surface of the layer of the inorganic material.

As used herein, the term “polymerised” includes within its scope any form of polymerisation of the organic functionalities of the organofunctional silane including oligomerisation of the organic functionalities. As used herein, the term “oligomerisation” includes within its scope oligomerisation of oligomers from two to twenty monomer units.

As used herein, the term “particles” is not particularly limited and is intended to include particles of any form. For example, but without limitation, the term is intended to include within its scope regular or irregular (i.e. non-spherical) particles, including lamellar particles.

As will be discussed in more detail below, the organofunctional silane component is preferably covalently bound to the inorganic component.

The at least one organofunctional silane component having organic functionalities which have not been polymerised is preferably formed from an organofunctional silane with the formula:

R¹ₙR²ₘSiX₍₄₋ₙ₋ₘ₎ (I)

wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

In a preferred embodiment R¹ or independently R² is selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C_{E})-arylalkyl; (C₈-C₄₀)-alkenylaryl-, (C₅-C₄₀)-cycloalkyl-, (C₆-C₄₀)-alkylcycloalkyl- or (C₆-C₄₀)-cycloalkylalkylsilane.

More preferably, R¹ or independently R² is selected from the group consisting of (C₁-C₄₀)-alkyl-, (C₁-C₄₀)-fluorinated alkyl-, (C₁-C₄₀)-partly fluorinated alkyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₅-C₄₀)-cycloalkyl-, (C₆-C₄₀)-alkylcycloalkyl- or (C₆-C₄₀)-cycloalkylalkylsilane.

For example, R¹ or independently R² may be selected from the group consisting of (C₄-C₁₀)-alkyl-, (C₆-C₁₂)-aryl-, (C₇-C₄₀)-alkylaryl-, (C₇-C₄₀)-arylalkyl-, fluorinated (C₇-C₁₆)-alkylaryl-, (C₅-C₄₀)-cycloalkyl-, (C₆-C₁₆)-alkylcycloalkyl- or (C₆-C₁₆)-cycloalkylalkylsilane.

Most preferably, R¹ or independently R² is selected from the group consisting of (C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

In certain embodiments R¹ or independently R² is selected from the group consisting of methyl, ethyl, propyl, n-butyl, iso-butyl or phenyl.

In certain embodiments, the hybrid inorganic/organic layer further comprises an aminosilane. For example, the hybrid inorganic/organic layer may additionally comprise a hydrolysed aminosilane, such as 3-aminopropyltriethoxysilane.

The selection of the core particles is not particularly limited. For example, these may be metallic core particles, or particles of other suitable material. In certain embodiments, the core particles comprise silica-based particles, such as organosiloxane particles loaded with a dopant or active. The inventive concepts may apply to any situation where protection of a dissolvable core particle or protection from leaching of the dopant or active is desired, or in cases where a core particle could potentially come into contact with a reactive external environment.

The inorganic component is generally a metal oxide, although other alternatives may be suitably employed. Preferably, the metal oxide is an oxide of a metal selected from the group consisting of silicon, aluminium, titanium, zirconium, iron, cerium, chrome, manganese, zinc, tin, antimony, boron, magnesium or mixtures thereof.

In one particular embodiment the core particles consists of organosiloxane particles loaded with a dopant or active and the inorganic component is silica.

In certain embodiments, the hybrid inorganic/organic layer further comprises an aminosilane. For example, the hybrid inorganic/organic layer may additionally comprise a hydrolysed aminosilane, such as 3-aminopropyltriethoxysilane.

The aminosilane is preferably used as a catalyst for catalysing the sol-gel reaction leading to the formation of the inorganic network, preferably a metal oxide network.

If the inorganic network is a metal oxide the aminosilane is itself hydrolysed and at least part of it is covalently bound to the inorganic network which can be, for example, schematically depicted by the following reaction schema:

M—OH+NH₂—R—Si(OH)₃→M—O—Si(OH)₂—R—NH₂+H₂O (II)

R represents an appropriate organic residue and M-OH represents a metal atom embedded in a metal oxide network, but still having at least one hydroxy function. The aminosilane is thus at least partly incorporated into the hybrid layer.

The aminosilane is thought to catalyse the condensation step of the sol-gel reaction leading to the formation of the inorganic network.

The thickness of the hybrid material coating is not particularly limited, provided this has the desired effect of ameliorating or eliminating leaching of the core particle, in particular dopants or actives within the core particle, from the coated particle and ameliorating or eliminating ingress of surrounding medium into the core particle. In that regard, it has been found difficult to identify the thickness of the coating layer due to similarities in the chemical composition of the layer and the core particle, at least so far as the example below are concerned. It is thought that the thickness of the coating will be up to 500 nm, generally from 10-100 nm, more preferably from 10-75 nm, although the scope of the invention is not bound to this range.

When the inorganic component is a metal oxide, the ratio of organofunctional silane component having organic functionalities which have not been polymerised to metal oxide of the hybrid layer is generally in a range of 1:1 to 10:1, more preferably in a range of 2:1 to 5:1, based on molar ratios of Si from the organofunctional silane to metal M of metal oxide. In a preferred embodiment, the metal oxide of the inorganic network is silica and thus the above mentioned ratios are based on molar ratios of Si of the organofunctional silane and silica.

The ratio of core particle to hybrid layer will be dependent on a number of factors, including for example the size of the core particle and the thickness of the hybrid layer. In certain embodiments, the ratio of core particle to hybrid inorganic/organic layer is from 7:1 to 1:8.

It will be appreciated that there are difficulties involved in determining the amount of aminosilane incorporated into the hybrid layer. Without wanting to be bound to the level of incorporation, it is thought that the amount of aminosilane incorporated into the hybrid layer will be in the vicinity of from 1-40 wt %.

In certain preferred embodiments the hybrid inorganic/organic layer comprises a hybrid silica/organosiloxane layer and the organosiloxane component of the layer is selected from phenylsiloxane and vinylsiloxane. It has been found that the admixture of some organically modified silica into the hybrid layer advantageously increases the ductility of the hybrid layer.

The coated particles may take any suitable form, for example dependent on the particular application of the coated particles. In certain embodiments, the coated particles are in the form of a powder or a paste further comprising a dispersant.

In another aspect there is provided a method of coating particles comprising:
combining the particles with a surfactant and a hydrophilic liquid to form an emulsion comprising a hydrophobic phase containing the particles dispersed in a continuous hydrophilic phase;
adding an organofunctional silane and an inorganic component precursor to the emulsion and heating the emulsion;
adding a catalyst to the emulsion; and
forming a hybrid organic/inorganic layer from the organofunctional silane precursor and the inorganic component precursor on the particles to produce coated particles.

As with the previous aspect of the disclosure, the organofunctional silane preferably has the formula:

R¹ₙR²ₘSiX₍₄₋ₙ₋ₘ₎ (I)

wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

Again, R¹ or independently R² is preferably selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇₋-C₄₀)-alkylaryl-, fluorinated (C₇-C₄₀)-arylalkyl-, partly fluorinated (C₇-C₄₀)-alkylaryl -; partly fluorinated (C₇-C₄₀)-arylalkyl; (C₈-C₄₀)-alkenylaryl-, (C₅-C₄₀)-cycloalkyl-, (C₆-C₄₀)-clkylcycloalkyl- or (C₆-C₄₀)-cycloalkylalkylsilane.

More preferably, R¹ or independently R² is selected from the group consisting of (C₁-C₄₀)-alkyl-, (C₁-C₄₀)-fluorinated alkyl-, (C₁-C₄₀)-partly fluorinated alkyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₅-C₄₀)-cycloalkyl-, (C₆-C₄₀)-alkylcycloalkyl- or (C₆-C₄₀)-cycloalkylalkylsilane.

More preferably, R¹ or independently R² is selected from the group consisting of (C₄-C₁₀)-alkyl-, (C₆-C₁₂)-aryl-, (C₇-C₄₀)-alkylaryl-, (C₇-C₄₀)-arylalkyl-, fluorinated (C₇-C₁₆)-alkylaryl-, (C₅-C₄₀)-cycloalkyl-, (C₆-C₁₆)-alkylcycloalkyl- or (C₆-C₁₆)-cycloalkylalkylsilane.

Most preferably, R¹ or independently R² is selected from the group consisting of (C₁-C₁₀)-alkyl-, (C₆-C₁₂)-aryl-, (C₇-C₁₂)-alkylaryl-, (C₇-C₁₂)-arylalkyl-, (C₅-C₁₀)-cycloalkyl-, (C₆-C₁₁)-alkylcycloalkyl- or (C₆-C₁₁)-cycloalkylalkylsilane.

In certain embodiments R¹ or independently R² is selected from the group consisting of methyl, ethyl, propyl, n-butyl, iso-butyl or phenyl.

Once again, the core particles may comprise silica-based particles. For example, the core particles may comprise organosiloxane particles loaded with a dopant or active.

Likewise, the inorganic component precursor is preferably a metal oxide precursor. For example, the metal oxide precursor may be a precursor of an oxide of a metal selected from the group consisting of silicon, aluminium, titanium, zirconium, iron, cerium, chrome, manganese, zinc, tin, antimony, boron, magnesium and a mixture thereof. Preferably, the metal oxide precursor is a tetraalkoxysilane, more preferably tetraethylalkoxysilane.

The selection of the surfactant is not particularly limited. The surfactant may be cationic, anionic, non-ionic or zwitterionic. It may be for example an alkylphenol ethoxylate, an alkyl (straight or branched chain) alcohol ethoxylate, an ethylene oxide-propylene oxide copolymer or some other type of surfactant. Suitable alkylphenolethoxylates may have alkyl groups between 6 and 10 carbon atoms long, for example 6, 7, 8, 9 or 10 carbon atoms long, and may have an average number of ethoxylate groups between about 7 and 15, or between about 8 and 10, or for example about 7, 8, 9, 10, 11 or 12. The surfactant may, when dispersed or dissolved in water have a pH of between about 3.5 and 7, or between about 4 and 6, 4 and 5, 5 and 6 or 6 and 7. Suitable surfactants include PEG-9 nonyl phenyl ether (e.g. NP-9), PEG-9 octyl phenyl ether (e.g. Triton X-100) or PEG-8 octylphenyl ether (e.g. Triton X-1 14). An example for an anionic surfactant is SDS. Another alternative for the surfactant is polyoxyethylene-10-tridecylether.

In certain embodiments, the surfactant is a water soluble, non-ionic surfactant with HLB between 8 and 20, or between about 10 and 15, or 10 and 14, for example a polyoxyethylene 10-tridecyl ether. It is also envisaged that in certain embodiments it may be appropriate to employ ionic surfactants and this alternative is included within the ambit of the disclosure.

The hydrophilic liquid that forms the hydrophilic phase in the emulsion is preferably water and/or alcohol. For example, this may include a water/ethanol solution. The hydrophilic liquid may be a mixture of water and alcohol, wherein the ratio of water to alcohol is in a range of 20:1 to 2:1 by weight.

The weight ratio of the organofunctional silane and the inorganic component precursor is preferably in a range of 10:1 to 1.5:1, preferably from 5:1 to 2:1.

It has been very surprisingly found that the addition of the surfactant led to the formation of a hydrophobic phase containing the the particles, the organofunctional silane and the inorganic component precursor dispersed as an oil-in-water emulsion in the hydrophilic liquid. The size of this hydrophobic phase is mainly determined by the size of the particles which is additionally surrounded by the organofunctional silane and the inorganic component precursor.

The ratio of surfactant:[particles+inorganic precursor+organofunctional silane] is preferably within the range of 3:1 to 0.5:1. If the amount of the surfactant is too low, it may be difficult to form a stable emulsion and the resulting pigments may have less desirable properties. If the amount is too high, secondary undesirable precipitation of hybrid inorganic/organic material not coating the particles may be observed. It is considered that micelles not containing particles are formed in the emulsion leading to these secondary precipitations.

Generally, the amount of the surfactant is predicated by the specific area of the particles. For example, fine particles have a larger specific surface. The amount of surfactant may be adapted to the particles and the amounts of inorganic precursor material and of organofunctional silane. Generally, the amount will be maintained as low as possible as residues of the surfactant will be found in the final product. The residual surfactant may be beneficial to the coated pigment. However, too large amounts should be avoided. The amount of residual surfactant in the coated product may be reduced by washing procedures after the coating step and after recovering the pigments.

Combining of the particles with the surfactant and the hydrophilic liquid to form the emulsion according to this aspect of the disclosure may be achieved by any suitable means. For example, combining the particles with the surfactant and the hydrophilic liquid to form the emulsion may comprise one or more of mixing, agitating, stirring and shaking. Combining of the particles with the surfactant and the hydrophilic liquid to form the emulsion is generally conducted for a period of time sufficient to homogenise the mixture. The subsequent addition of the organofunctional silane precursor and the inorganic component precursor is also preferably conducted with at least one of mixing, agitating, stirring and shaking.

The addition of the catalyst advantageously results in the rapid condensation of the coating onto the particles from the organofunctional silane precursor and the inorganic component precursor in the hydrophobic phase. In a preferred embodiment, the catalyst is a hydrolysed am inosilane, such as 3-aminopropyltriethoxysilane.

In preferred embodiments, although the invention is not so limited, after addition of the catalyst the resulting mixture is left for a period of from 2 to 4 hours with one or more of mixing, agitating, stirring and shaking to facilitate formation of the layer on the particles.

The method for recovering the coated particles is not particularly limited. However, in a preferred embodiment recovering the coated particles comprises centrifugation or filtering with washing of the coated particles and optionally re-centrifugation or re-filtering of the washed coated particles.

It is envisaged that it may also be possible to alter the sequence of addition of the components of the emulsion. As such, in another aspect, disclosed is a method of coating particles comprising:
combining the particles with a surfactant and an organofunctional silane and an inorganic component precursor to form a hydrophobic phase;
combining the hydrophobic phase with a hydrophilic liquid to form an emulsion comprising the hydrophobic phase containing the particles, the organofunctional silane and the inorganic component precursor dispersed in a continuous hydrophilic phase;
adding a catalyst to the emulsion; and
forming a coating from the organofunctional silane and the inorganic component precursor on the particles to produce coated particles.

Combining of the hydrophobic phase and the hydrophilic liquid may be achieved by any suitable means. For example, combining the hydrophobic phase and the hydrophilic liquid may comprise one or more of mixing, agitating, stirring and shaking the combined hydrophobic phase and the hydrophilic liquid.

The disclosed method advantageously facilitates deposition of a layer, which may be termed a “hybrid” layer. That is, a hybrid inorganic/organic layer that encapsulates a core particle. In preferred embodiments, the hybrid layer is formed from a metal oxide and an organofunctional silane precursor, for example an alkoxysilane or organoalkoxysilane, such as tetraorthoethylsilicate, or an alkyltrialkoxysilane such as vinyltriethoxysilane or phenyltrimethoxysilane, or a combination thereof. It is envisaged that the inorganic component precursor may also include a titanium alkoxide (e.g. titanium tetraethoxide, titanium isopropoxide, titanium sec butoxide titanium tert-butoxide), a zirconium alkoxide (e.g. zirconium propoxide, zirconium butoxide), or an aluminium alkoxide (e.g. aluminium sec butoxide).

The temperature of the reaction is preferably between 25° C. and 80° C., more preferably between 30° C. and 60° C. and most preferable between 35 and 50° C. Usually a reaction temperature of about 40° C. is sufficient. As such, the process advantageously provides for relatively low energy consumption.

The disclosed embodiments consist of features and a combination of parts hereinafter fully described and illustrated in the accompanying drawings and examples, it being understood that various changes in the details may be made without departing from the scope of the invention or sacrificing any of the advantages of the present invention.

### BRIEF DESCRIPTION OF ACCOMPANYING DRAWINGS

To further clarify various aspects of some embodiments disclosed herein, a more particular description will be rendered by references to specific embodiments, which are illustrated in the appended drawings and exemplified in the examples. It should be appreciated that the drawings depict only typical embodiments of the invention and are therefore not to be considered limiting on its scope. The invention will be described and explained with additional specificity and detail through the accompanying drawings in which:

FIG. 1 illustrates a flow diagram of a method of an embodiment of the disclosed particles and method.

FIG. 2 illustrates a TEM image of control (left) and coated (right) particles of example 3.

### DETAILED DESCRIPTION OF THE PREFERRED EMBODIMENTS

As mentioned above, the disclosure relates to coated particles and a method of coating particles. In particular, the disclosure relates to a method of coating particles, such as silica-based particles loaded with an active or other dopant, whereby a hybrid inorganic/organic layer is coated onto the particles. The coating advantageously reduces or eliminates exposure of the core particles to the external environment.

Hereinafter, the present invention will be described and exemplified in more detail according to the preferred embodiments. It is to be understood that the following discussion of the invention is provided without intending any limitation thereon and without departing from the spirit of the invention as defined in the appended claims.

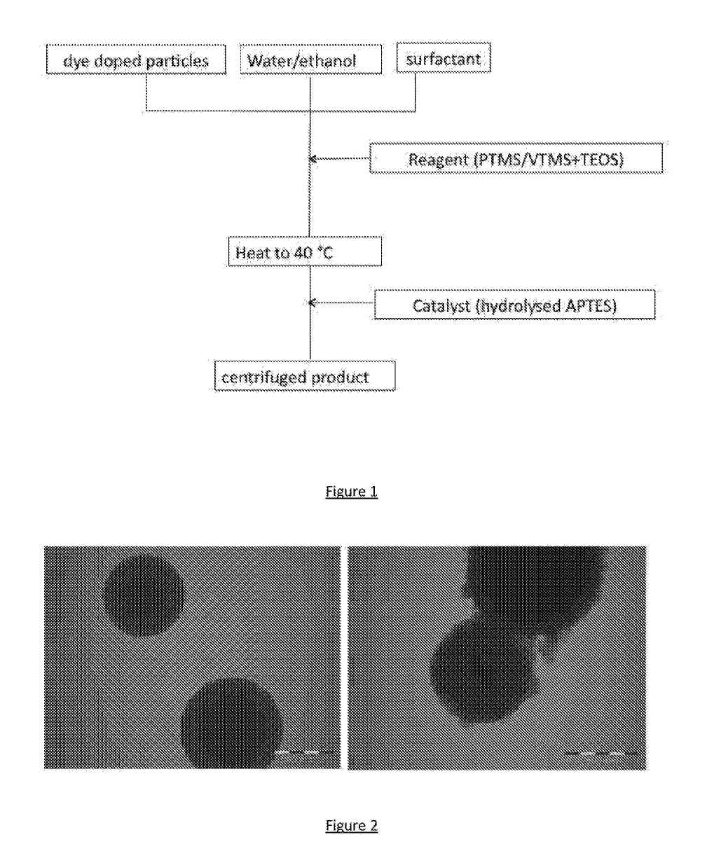

A summary of the general coating method is shown in FIG. 1. While this refers to coating of dye doped particles, it will be appreciated that this is provided for exemplification only and that the invention is no so limited.

Referring to FIG. 1, dye doped particles are combined with a surfactant and solvent and stirred until homogeneous. A reagent that contains a precursor to the coating is added, in this case a reagent containing PTMS (phenyltrimethoxysilane) or VTMS (vinyltrimethoxysilane) and TEOS (tetraethylorthosilicate). Again, the mixture is stirred until homogeneous.

The particle dispersion is heated to 40° C. and a catalyst is added, in this case hydrolysed APTES (3-aminopropyltriethoxysilane). The resulting mixture is stirred for approximately 2 hours.

The resulting coated particles are then recovered by centrifugation with washing of the recovered particles, optionally with re-centrifugation of the washed particles.

### EXAMPLES

Phenylsiloxane particles containing a lipophilic dye show extensive leaching of the dye when immersed in solvent. Coating the particles with a silica/phenylsiloxane coating results in reduced leaching on exposure to solvent. A summary of the general coating method is illustrated in FIG. 1, as described above. Two experiments are described below—one using phenyltrimethoxysilane (PTMS) as the organosiloxane component of the coating, and a second experiment where vinyltrimethoxysilane (VTMS) was used.

### Example 1

A sample containing ˜1.25 g of phenylsiloxane particles doped with ˜24 wt % lipophilic dye was suspended in 50 mL of 4:1 water:ethanol mixture and 3.84 g of polyoxyethylene 10-tridecyl ether added to emulsify the particles with stirring overnight.

The sample was split in two, a first half to which additional sol-gel reagents were added as described below, and a second half to which no additional sol-gel reagents were added, thus acting as a non-coated control.

0.253 mL phenyltrimethoxysilane and 0.13 mL tetraethoxyorthosilicate was added to the first half, followed by heating of both samples to 40° C. When at temperature, 0.544 mL of 3-aminopropyltriethoxysilane solution in water (1:1 v/v solution) was added to the first half, and heating maintained for two hours. Finally, the solutions were cooled to ambient with continued stirring, then centrifuged. The isolated solids were washed once with water, recentrifuged and the washed solids resuspended in water with approx. 4-5 wt % solid in the resulting slurries.

Characterisation of Coated Sample from Example 1

Dried particles of both samples were immersed in toluene at a concentration of 10 mg/mL equivalent dye concentration in both solutions, and stirred for 30 minutes. The solutions were then centrifuged to sediment the particles, and the supernatant sampled for UV/Vis spectroscopy (monitoring absorbance at 344 nm) to determine the concentration of leached dye. The coated sample was found to have 37% of the estimated encapsulated dye released, compared with 65% for the control sample, indicating that the coating reduced the extent of leaching in the coated sample.

### Example 2

As was the case in example 1, a sample containing ˜1.25 g of phenylsiloxane particles doped with ˜24 wt % lipophilic dye was homogenized overnight in 50 mL of 4:1 water:ethanol with addition of 3.84 g polyoxyethylene 10-tridecyl ether. To a first half of this solution was added 0.311 mL (2 mMol) of vinyltrimethoxysilane and 0.195 mL of tetraethylorthosilicate, followed by heating of both the first half and a second half to 40° C., and addition of 0.816 mL of 3-aminopropyltriethoxysilane solution in water (1:1 v/v solution) to the first half. After heating for two hours, the samples were cooled, centrifuged and washed as above, and resuspended in aqueous slurries.

Additional samples containing increased amounts of sol-gel reagents were prepared as below:
a) 0.467 mL vinyltrimethoxysilane (3 mMol), 0.293 mL tetraethylorthosilicate, and 1.224 mL of 3-aminopropyltriethoxysilane solution in water (1:1 v/v solution); and
b) 0.622 mL vinyltrimethoxysilane (4 mMol), 0.39 mL tetraethylorthosilicate and 1.632 mL 3-aminopropyltriethoxysilane solution in water (1:1 v/v solution).
   Characterisation of Coated Samples from Example 2

Analysis of the particle size distribution using static light scattering show a small but progressive increase in the average particle size with increased amounts of coating reagent. The d0.5 values were 204, 231, 234 and 247 nm for the control, and samples prepared using 2, 3 and 4 mMol VTMS respectively.

To measure leaching, particles were stirred for 30 minutes in toluene at a concentration equivalent to 10 mg/mL of dye. The extent of leaching determined by UV/Vis absorption at 344 nm was found to be 79, 21, 5 and 3% for the control, and the samples prepared using 2, 3, and 4 mMol VTMS respectively.

### Example 3

A sample containing ˜2.5 g of phenylsiloxane particles doped with cerium acetylacetonate was stirred overnight in 100 mL of 4:1 water:ethanol, to which 7.68 g of polyoxyethylene 10-tridecyl ether was added. The sample was then divided in two, and to one half was added (with stirring) 1.244 mL of vinyltrimethoxysilane and 0.78 mL of tetraethylorthosilicate, whereas no further reagent was added to the other half (control solution). Both solutions were then heated with stirring to 40° C., at which point 3.264 mL of 3-aminopropyltriethoxysilane solution in water (1:1 v/v solution) was added to the first half. After heating for two hours, the samples were cooled, centrifuged and washed as above, and resuspended in aqueous slurries.

Characterisation of Coated Samples from Example 3

Scanning electron microscope images of the control sample indicate that the original phenylsiloxane particles have a wide size distribution of 400-6000 nm.

In contrast, in addition to the larger particles, the coated sample contains very small (˜70 nm) particles, indicating some secondary particle formation has occurred.

Transmission electron microscopy images of the control (left) and coated (right) samples are shown in FIG. 2. The rough surface of the coated particles contrast with the sharp interface of the control particles, indicating an outer layer of vinylsiloxane/silica.

### SUMMARY

Coatings consisting of both phenylsiloxane and vinylsiloxane with silica on a particle core containing encapsulated hydrophobic molecules have been found to reduce the extent of leaching of the encapsulated molecules on immersion in solvents. Increasing the amount of reagent used to form the coating resulted in decreased leaching of the active, as demonstrated by use of a lipophilic dye leaching on exposure to toluene.

### CONCLUSION

A method has been developed that produces a protective coating on particles using a water soluble surfactant to emulsify the particles in a water-based emulsion, and addition of sol-gel reagents to form a hybrid material layer which adheres to the particle surface. Experiments have shown that this layer can act to reduce interaction with the surrounding medium by reducing degradation of the core material by preventing or slowing ingress of destabilizing elements in the surrounding medium. Moreover, the coating reduces leaching of encapsulated hydrophobic molecules from the particles into the surrounding medium.

Unless the context requires otherwise or specifically stated to the contrary, integers, steps or elements of the disclosed embodiments recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. Coated particles comprising:
a core particle excluding an aluminium core particle; and
a hybrid inorganic/organic layer coating said core particle,
wherein said hybrid inorganic/organic layer comprises a network of an inorganic component and at least one organofunctional silane component having organic functionalities which have not been polymerised.

2. Coated particles according to claim 1, wherein the organofunctional silane component is covalently bound to the inorganic component.

3. Coated particles according to claim 1, wherein said at least one organofunctional silane component having organic functionalities which have not been polymerised has been formed from an organofunctional silane with the formula:
R¹ₙR²ₘSiX₍₄₋ₙ₋ₘ₎ (I)
wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

4. Coated particles according to claim 3, wherein R¹ or independently R² is selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇₋-C₄₀)-alkylaryl-; partly fluorinated (C₇-C₄₀)-arylalkyl; (C₈-C₄₀)-alkenylaryl-, (C₅-C₄₀)-cycloalkyl-, (C₆-C₄₀)-alkylcycloalkyl- or (C₆-C₄₀)-cycloalkylalkylsilane.

5-6. (canceled)

7. Coated particles according to claim 3, wherein R¹ or independently R² is selected from the group consisting of methyl, ethyl, propyl, n-butyl, iso-butyl or phenyl.

8. Coated particles according to claim 1, wherein the hybrid inorganic/organic layer further comprises an am inosilane.

9. Coated particles according to claim 1, wherein the core particles comprise silica-based particles, such as organosiloxane particles loaded with a dopant or active.

10. Coated particles according to claim 1, wherein the inorganic component is an oxide of a metal selected from the group consisting of silicon, aluminium, titanium, zirconium, iron, cerium, chrome, manganese, zinc, tin, antimony, boron, magnesium and a mixture thereof.

11-12. (canceled)

13. Coated particles according to claim 1, wherein the inorganic component is a metal oxide and the ratio of organofunctional silane component having organic functionalities which have not been polymerised to metal oxide of the hybrid layer is in a range of 1:1 to 10:1, preferably in a range of 2:1 to 5:1, based on molar ratios of Si from the organofunctional silane to metal M of metal oxide.

14. Coated particles according to claim 1, wherein said hybrid inorganic/organic layer has a thickness of up to 500 nm, preferably from 10 to 75 nm.

15. Coated particles according to any one of the claim 1, wherein the ratio of core particle to hybrid inorganic/organic layer is from 7:1 to 1:8.

16. Coated particles according to claim 1, wherein said hybrid inorganic/organic layer comprises a hybrid silica/organosiloxane layer and said organosiloxane component of the layer is selected from phenylsiloxane and vinylsiloxane.

17. Coated particles according to claim 1, wherein the coated particles are in the form of a powder or a paste further comprising a dispersant.

18. A method of coating particles, excluding aluminium particles, comprising:
combining said particles with a surfactant and a hydrophilic liquid to form an emulsion comprising a hydrophobic phase containing said particles dispersed in a continuous hydrophilic phase;
adding an organofunctional silane and an inorganic component precursor to said emulsion and heating said emulsion;
adding a catalyst to said emulsion; and
forming a hybrid organic/inorganic layer from said organofunctional silane and said inorganic component precursor on said particles to produce coated particles.

19. A method according to claim 18, wherein said organofunctional silane has the formula:
R¹ₙR²ₘSiX₍₄₋ₙ₋ₘ₎ (I)
wherein X is a group capable for hydrolysis and for forming a chemical bond to the inorganic component after hydrolysis and R¹ and R² are independently a non-reactive organic group with the proviso, that n and m are integers, wherein n+m=1-2 and n=1-2 and m=0-1.

20. A method according to claim 19, wherein R¹ or independently R² is selected from the group consisting of (C₁-C₄₀)-alkyl-, (C₁-C₄₀)-fluorinated alkyl-, (C₁-C₄₀)-partly fluorinated alkyl-; (C₂-C₄₀)-alkenyl-; (C₆-C₃₆)-aryl-, fluorinated (C₆-C₃₆)-aryl-, partly fluorinated (C₆-C₃₆)-aryl-; (C₇-C₄₀)-alkylaryl-, (C₇-C₄₀)-arylalkyl-, fluorinated (C₇-C₄₀)-alkylaryl-, fluorinated (C₇-C₄₀)-arylalkyl-, partly fluorinated (C₇-C₄₀)-alkylaryl-; partly fluorinated (C₇-C₄₀)-arylalkyl; (C₈-C₄₀)-alkenylaryl-, (C₅-C₄₀)-cycloalkyl-, (C₆-C₄₀)-clkylcycloalkyl- or (C₆-C₄₀)-cycloalkylalkylsilane.

21-23. (canceled)

24. A method according to claim 18, wherein the core particles comprise silica-based particles, such as organosiloxane particles loaded with a dopant or active.

25. A method according to claim 18, wherein said inorganic component precursor is an oxide of a metal selected from the group consisting of silicon, aluminium, titanium, zirconium, iron, cerium, chrome, manganese, zinc, tin, antimony, boron, magnesium and a mixture thereof.

26. (canceled)

27. A method according to claim 25, wherein the metal oxide precursor is a tetraalkoxysilane, preferably tetraethylalkoxysilane.

28. A method according to claim 18, wherein said surfactant is a water soluble, non-ionic surfactant with HLB ranging from 8-20.

29. A method according to claim 28, wherein said surfactant is polyoxyethylene 10-tridecyl ether.

30. A method according to claim 18, wherein said hydrophilic liquid is water and/or alcohol, for example a mixture of water and alcohol wherein the amount of water to the amount of alcohol is in a range of 20:1 to 2:1 by weight.

31. A method according to claim 18, wherein said catalyst is a hydrolysed aminosilane, preferably 3-aminopropyltriethoxysilane.

32. A method according to claim 18, wherein the weight ratio of the organofunctional silane and the inorganic component precursor is in a range of 10:1 to 1.5:1, preferably from 5:1 to 2:1,based on molar Si-ratios.

33. A method according to claim 18, wherein combining said particles with said surfactant and said hydrophilic liquid to form said emulsion comprises one or more of mixing, agitating, stirring and shaking.

34. A method according to claim 33, wherein combining said particles with said surfactant and said hydrophilic liquid to form said emulsion is conducted for a period sufficient to homogenise the mixture.

35. A method according to claim 18, wherein after addition of said catalyst the resulting mixture is left for a period of time with one or more of mixing, agitating, stirring and shaking to facilitate formation of said coating on said particles.

36. A method according to claim 18, further comprising recovering said coated particles by centrifugation or filtering with washing of said coated particles and optionally re-centrifugation or re-filtering of said washed coated particles.
